(19) United States
(12) Patent Application Publication
(10) Pub. No.: US 2001/0054344 A1
(43) Pub. Date: Dec. 27, 2001

(54) Die holder

(76) Inventor: Hiroichi Sakamoto, Kagamihara-shi (JP)

Correspondence Address: ARMSTRONG,WESTERMAN, HATTORI,, MCLELAND & NAUGHTON, LLP, 1725 K STREET, NW, SUITE 1000, WASHINGTON, DC, 20006, US

(21) Appl. No.: 09/531,230

(22) Filed: Mar. 20, 2000

(30) Foreign Application Priority Data
Apr. 19, 1999 (JP) 11-110689

(51) Int. Cl. B26D 1/00

(52) U.S. Cl. 83/698.91; 83/698.11

(57) ABSTRACT

The present invention provides a die holder wherein before inserting a die into a die installation hole, a clearance is obtained for easy insertion, whereas after insertion, the die can be locked in position without a gap, thereby allowing the die to be precisely locked in position using simple operations. A die holder body 13 has an expandable ring-shaped chamber 14 disposed around a die installation hole 13a therein and which comes in contact with a die 5 to tighten and lock it all over its circumference The chamber 14 is enlarged and contracted under the pressure of a working fluid such as oil which is sealed therein. The working fluid can be pressurized by screwing a pressure-applying screw 18 into a fluid passage 17 leading to the inside of the chamber 14.

### FIELD OF THE INVENTION

The present invention relates to a die holder that is mounted in a press machine such as a turret punch press.

### BACKGROUND OF THE INVENTION

In conventional turret punch presses, an upper turret has a large number of punches each installed thereon via a punch holder and a lower turret has a larger number of dies installed thereon via a die holder and corresponding to the punches. In replacing the die with new one, due to a small interval between the upper and lower turrets, the die holder with the die is first removed from the lower turret and the die is then removed from the die holder outside the machine. Next, a new die is installed on the die holder, which is then installed back in an original die holder station on the lower turret. In another case, a certain mechanism is used to remove the die from the die holder on the turret. To install the die on the die holder, the die is inserted into a die installation hole formed in the die holder, and screws disposed around the die installation hole at a plurality of locations are used to press a side surface of the die in order to press another side surface of the die against an inner surface of the die installation hole.

The die installation hole in the die holder has such an inner diameter as to form a small gap between the inner periphery of the die installation hole and the outer periphery of the die for easy die insertion and removal. If screws are used to press a side surface of the die for fixation as in the conventional structure, the above gap causes the die to be locked in the die installation hole in such a manner as to be biased in a direction in which the screws were initially tightened. Thus, the die may be decentered relative to the die holder, thereby affecting punch working accuracy and quality.

The present invention is provided to solve this problem, and it is an object of the present invention to provide a die holder that enable the die to be precisely locked in the center of the die installation hole and that enable the die to be easily installed in and removed from the die holder.

It is another object of the present invention to enable the precise fixation using a simple structure.

### SUMMARY OF THE INVENTION

To attain these objects, the present invention provides a die holder comprising a die holder body having a die installation hole in which a die can be installed, an expandable chamber disposed around the die installation hole in such a way as to come in contact with the die to tighten and lock it in position, and enlarging and contracting operation means for enlarging and contracting this chamber.

With this construction, when the die is installed in the die installation hole in the die holder body and the enlarging and contracting operation means is used to reduce the inner diameter of the chamber, the die is tightened and locked in the chamber. In addition, when the enlarging and contracting operation means is used to increase the inner diameter of the chamber, the die is released from tightening by the chamber. Thus, the die can be easily installed in and removed from the die holder and can be locked in position so as not to form a gap between the outer periphery of the die and the inner periphery of the die installation hole. In addition, the chamber can apply a continuous uniform pressure to the periphery of the die to correctly lock it in the center of the die holder. That is, this construction provides a centering effect.

In this die holder, the chamber may be shaped like a ring disposed around an inner peripheral surface of the die installation hole and in which an working fluid can be sealed, and the enlarging and contracting operation means may comprise a fluid passage leading to the inside of the chamber and screw means screwed into the fluid passage to apply pressure to the working fluid sealed in the fluid passage and the chamber.

With this construction, when the die is inserted into the die installation hole and the screw means is screwed into the fluid passage to apply pressure to the working fluid in the chamber, an inner-periphery-side wall section of the chamber is expanded to reduce the diameter of the chamber. Thus, the die is tightened by the chamber all over its circumference and is thus locked in the die holder. In this manner, since the diameter of the chamber is reduced to tighten the die all over its circumference for fixation, the die is precisely locked in the die installation hole without a gap or eccentricity. Loosening the screw means releases the chamber from the working fluid pressure to cancel its expansion, thereby forming a gap between the inner-periphery-side wall section of the chamber and the outer periphery of the die, so that the die can be removed freely. In this manner, the die can be installed in and removed from the chamber simply by using an inner diameter side of the chamber for installation and removal and operating the screw means for applying pressure to the chamber. In addition, this construction is simple because the enlarging and contracting operation means for the chamber is constructed to apply pressure to the working fluid when the screw means is screwed into the fluid passage.

The screw means may be disposed in a machine exterior portion of the die holder relative to a press machine in which the die holder body is installed, that is, a portion of the die holder closer to the exterior of the press machine. The screw means may be disposed in an arbitrary machine exterior portion of the die holder, for example, in a portion of the die holder facing the exterior of the press machine or on a top surface thereof. When the screw means is disposed in the machine exterior portion of the die holder, chamber enlarging and contracting operations can be simply performed externally of the press machine.

### BRIEF DESCRIPTION OF THE DRAWING

FIG. 1A is a vertical sectional view of a die holder according to one embodiment of the present invention, and FIG. 1B is a partly cutaway top view of the die holder.

FIG. 2 is a schematic perspective view showing a turret section of a turret punch press with the die holders mounted therein.

FIG. 3 is a partly cutaway top view showing a general construction of the turret punch press.

### DETAILED DESCRIPTION OF THE PREFERRED EMBODIMENTS

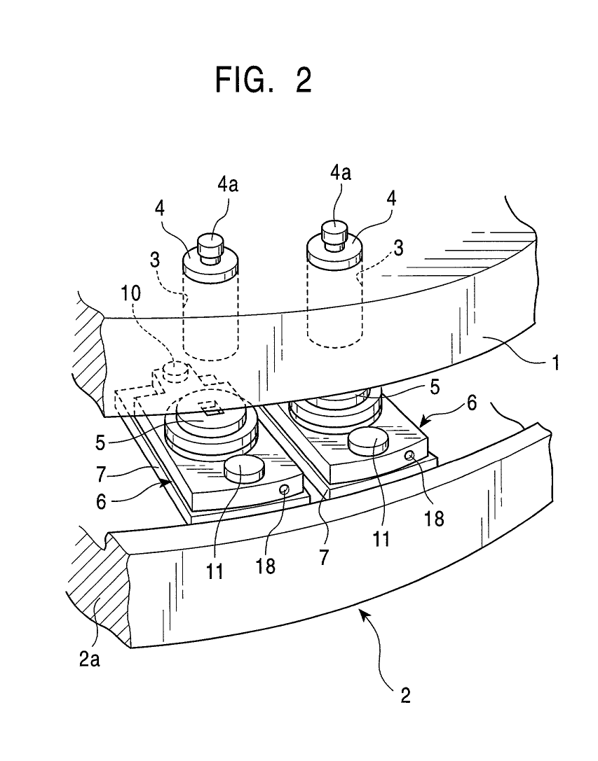

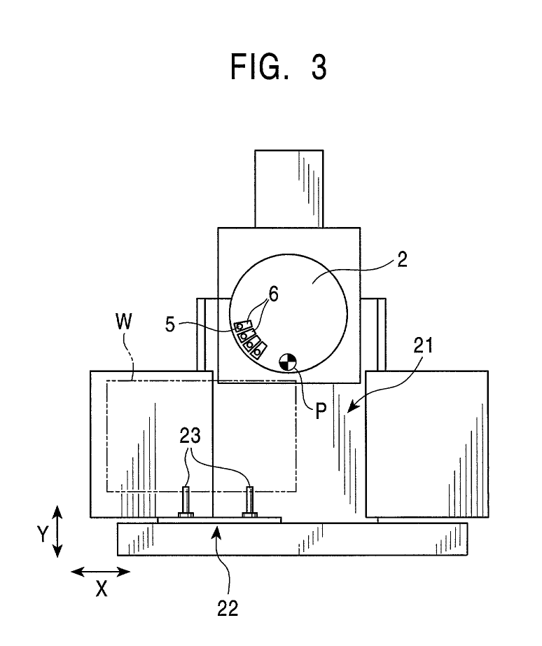

One embodiment of the present invention will be described with reference to the drawings. FIG. 2 is a schematic perspective view showing a turret section of a turret punch press with die holders mounted therein. FIG. 3 is a partly cutaway top view showing a general construction of the punch press. In FIG. 3, a table 21 is disposed around a lower turret 2, and a work W is fed on the table in directions X and Y while being gripped by work holders 23 of a work-feeding device 22.

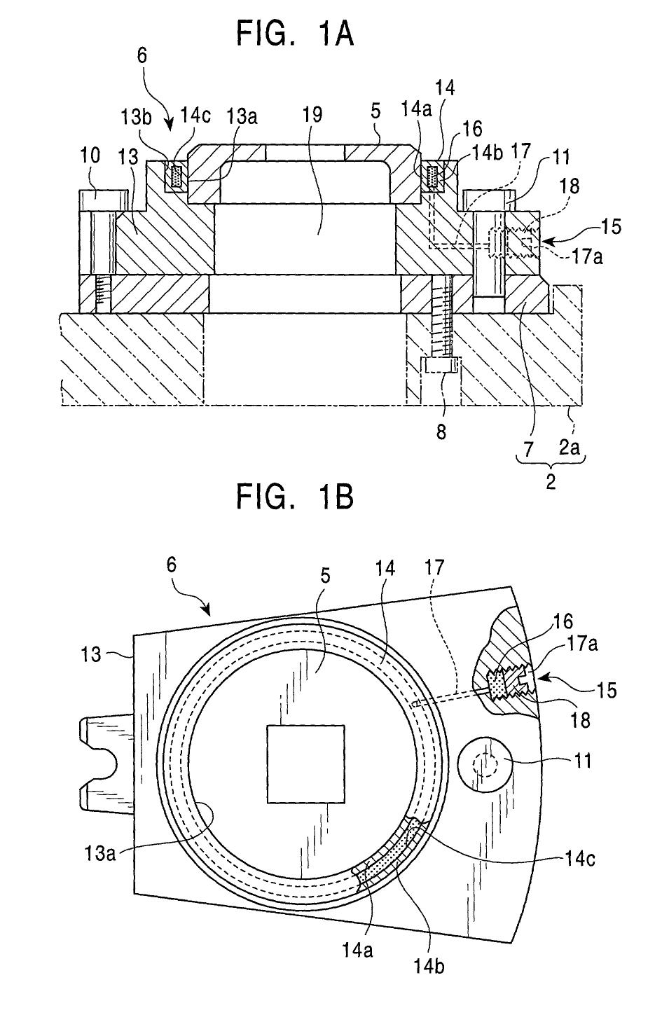

In FIG. 2, an upper turret 1 has punch-fitting holes 3 arranged in a circumferential direction of the punch press and each having a punch holder 4 fitted therein for free elevation. The punch holders 4 each have a built-in punch (not shown in the drawing) and a T-shaped head section 4a. The lower turret 2 has die holders 6 each installed on its top surface via a die base 7 and holding a die 5. The die base 7 is mounted on a top surface of a lower turret body 2a so that its mounting position can be fine-tuned using a plurality of bolts 8 (FIG. 1). The die holder 6 has its inner end in a radial direction of the turret engagingly locked on the die base 7 using an inner-end locking pin 10 and has its outer end engagingly locked on the die base 7 using a mounting pin 11.

As shown in FIG. 1, the die holder 6 comprises a die holder body 13 having a circular die installation hole 13a in which the die 5 can be installed, an expandable chamber 14 disposed around the die installation hole 13a in such a manner as to come in contact with the die 5 to tighten and lock it in position, and enlarging and contracting operation means 15 for enlarging and contracting the chamber 14.

The die holder body 13 has a generally fan-shaped planar shape and has the die installation hole 13a formed in its central position in the turret radial direction. The die installation hole 13a is a bottomed hole having an inner peripheral shape in which the die 5 is fitted for free insertion and removal, and has a drop hole 19 formed in its bottom surface for dropping scraps therethrough. The die installation hole 13a in the die holder body 13 is formed as a staged hole having a larger diameter in its upper part so that a chamber installation seat 13b is installed in the larger-diameter portion.

The chamber 14 is a ring-shaped container in which a working fluid 16 such as oil can be sealed and which has a peripheral wall section comprising a double wall including an inner peripheral wall section 14a and an outer peripheral wall section 14b in such a manner that a space between the inner and outer peripheral wall section 14a and 14b constitutes a working fluid sealing space 14c. The peripheral wall section 14a on the inner peripheral side can be elastically expanded toward an inner diameter side of the chamber 14 under the pressure of the working fluid 16 inside the chamber 14. This expansion of the peripheral wall section and its returning to its original shape causes the chamber 14 to be enlarged and contracted as described above. Although the chamber 14 is formed of metal or the like, the inner peripheral wall section 14a is expandable when having an appropriate board thickness. The chamber 14 has cylindrical inner and outer peripheral surfaces, which form the external shape of the chamber 14, and is fittingly locked on the chamber installation seat 13b of the die holder body 13, so that the inner peripheral surface of the chamber 14 constitutes part of the die installation hole in the die holder 6. Specifically, the outer peripheral wall section 14b of the chamber 14 is pressed into the chamber installation hole 13b without a gap. Deformation on pressurization occurs only on the inner side of the chamber in which the die 5 is locked. The chamber 14 may be integrally formed in the die holder body 13. That is, the working fluid sealing space 14c may be directly formed in the die holder body 13 so that the fluid pressure causes the peripheral wall section between the working fluid sealing space 14c and the inner peripheral surface of the die installation hole to be expanded toward the inner diameter side of the chamber

The enlarging and contracting operation means 15 is comprised of a fluid passage 17 leading to the working fluid sealing space 14c in the chamber 14 and a pressure-applying screw 18 that is pressure control means screwed into an internal-thread section 17a constituting part of the fluid passage 17. The pressure-applying screw 18 forms screw means for applying pressure to the working fluid 16 sealed in the fluid passage 17 and the chamber 14. The internal-thread section 17a of the fluid passage 17 is formed to be opened in an end portion of the die holder body 13 which faces an outer diameter side of the turret.

An operation for installing and removing the die 5 on and from the die holder 6. Before installation, the pressure-applying screw 18 of the enlarging and contracting operation means 15 is loosened. This operation increases the volume of the inside of the chamber 14 to reduce the pressure of the working fluid 16, thereby returning the inner peripheral wall section 14a of the chamber 14 from the expanded state to the original state under an elastic recovery force. Accordingly, the inner peripheral surface of the chamber 14, which constitutes the inner surface of the die installation hole 13a, moves in a fashion increasing the inner diameter of the die installation hole 13a up to a value slightly larger than the outer diameter of the die 5. Then, the die 5 is fitted in the die installation hole 13a in the die holder body 13. Next, the pressure-applying screw 18 is screwed into the fluid passage to apply pressure to the working fluid 16. Consequently, the inner diameter of the chamber 14 is reduced to tighten the die 5, which is thus locked in the die installation hole 13a in the die holder body 13.

To remove the die 5 from the die holder 6, the pressure-applying screw 18 is loosened to release the chamber 14 from expansion in order to increase its inner diameter, which has been reduced. This operation releases the die 5 from locking in the die installation hole 13a in the die holder body 13 to allow the die 5 to be removed.

In this manner, before inserting the die 5 into the die installation hole 13a in the die holder 6, a clearance is formed around the die installation hole 13a for easy insertion so that after placing the die 5 in the die installation hole 13a, the hole 13a can be tightened by the chamber 14 all over its circumference and locked in position without a gap. Consequently, the die is precisely mounted without being biased within the die installation hole 13a, thereby improving punch working accuracy and enabling the die 5 to be installed and removed easily.

Since the above simple operation can install and remove the die 5, the die 5 can be replaced with new one between the small space between the upper and lower turrets 1 and 2 without the need to remove the die holder 6 from the lower turret 2. In this case, the pressure-applying screw 18 is disposed in the end surface of the die holder body 13 which faces the outer diameter side of the lower turret 2, so that it can be easily operated while the die holder body 13 is mounted on the lower turret 2.

In addition, this construction is simple because the mechanism for locking the die 5 in the die installation hole 13a is comprised of the chamber 14 with the working fluid 16 sealed therein and the enlarging and contracting operation means 15 therefor. In addition, since the enlarging and contracting operation means 15 is comprised of the pressure-applying screw 18 fitted in the internal-thread section 17a of the fluid passage 17, this construction is simple and can be operated without using a pressure-applying device or the like.

The die holder according to the present invention comprises the die holder body having the die installation hole in which the die can be installed, the expandable chamber disposed around the die installation holes in such a way as to come in contact with the die to tighten and lock it in position, and the enlarging and contracting operation means for enlarging and contracting this chamber. Thus, the die can be locked in position so as not to form a gap between the outer periphery of the die and the inner periphery of the die installation hole. As a result, the die can be precisely locked in position, and its installation and removal operations are easy.

In addition, if the chamber is shaped like a ring in which the working fluid can be sealed, and the enlargement and contraction means is comprised of the fluid passage leading to the inside of the chamber and the screw means screwed into the fluid passage to apply pressure to the working fluid in the chamber, then the above precise fixation can be achieved using a simple construction.

If the screw means is disposed in the machine exterior portion of the die holder relative to the press machine in which the die holder body is installed, chamber enlarging and contracting operations can be performed externally of the press machine, thereby enabling easier operations.

1. A die holder characterized by comprising a die holder body having a die installation hole in which a die can be installed, an expandable chamber disposed around said die installation hole in such a way as to come in contact with said die to tighten and lock it in position, and enlarging and contracting operation means for enlarging and contracting this chamber.

2. A die holder as in claim 1, characterized in that said chamber is a ring disposed in contact with an inner peripheral surface of the die installation hole and in which an working fluid can be sealed, and in that said enlarging and contracting operation means uses the working fluid sealed inside the chamber to expand the chamber so as to center the die relative to the die installation hole.

3. A die holder as in claim 1 or claim 2, characterized in that said enlargement and contraction means comprises a fluid passage leading to the inside of said chamber and pressure operation means capable of applying pressure to the fluid passage and the working fluid sealed in said chamber.

4. A die holder as in claim 3, characterized in that said pressure control means comprises screw means screwed into said fluid passage so as to advance and recede therein to regulate the pressure of the working fluid.

5. A die holder as in claim 3, characterized in that when installed in a press machine in which said die holder is installed, said pressure control means is located on a maintenance side of the press machine.
